(19) United States
(12) Patent Application Publication
(10) Pub. No.: US 2016/0159353 A1
(43) Pub. Date: Jun. 9, 2016

(54) SMART CRUISE CONTROL SYSTEM FOR VEHICLES AND CONTROL METHOD THEREOF

(71) Applicant: HYUNDAI MOBIS Co., Ltd, Seoul (KR)

(72) Inventor: Ju Kyeong YUN, Ansan-si (KR)

(73) Assignee: HYUNDAI MOBIS Co., Ltd, Seoul (KR)

(21) Appl. No.: 14/956,959

(22) Filed: Dec. 2, 2015

(30) Foreign Application Priority Data
Dec. 3, 2014 (KR) 10-2014-0171966

(51) Int. Cl. B60W 30/14

(52) U.S. Cl. CPC B60W 30/143; B60W 2550/14

(57) ABSTRACT

Provided is a smart cruise control (SCC) system. The SCC system includes a control unit configured to determine a road environment, in which a driver's vehicle is driving, based on road information supplied from a navigation, choose a target vehicle from among preceding vehicles by using a parameter which is adaptively set depending on the determined road environment, and calculate a target acceleration of the driver's vehicle, based on the chosen target vehicle and a braking unit configured to control acceleration or deceleration of the driver's vehicle, based on the target acceleration.

### CROSS-REFERENCE TO RELATED APPLICATIONS

This application claims priority under 35 U.S.C. §119 to Korean Patent Application No. 10-2014-0171966, filed on Dec. 3, 2014, the disclosure of which is incorporated herein by reference in its entirety.

### TECHNICAL FIELD

The present invention relates to a smart cruise control (SCC) system for vehicles and a control method thereof, and more particularly, to an SCC system and a control method thereof, which control acceleration or deceleration of a driver's vehicle so as to maintain a safe distance from a preceding vehicle.

### BACKGROUND

Generally, an SCC system denotes a system that detects a distance from a preceding vehicle by using radar installed in a vehicle and decelerates or accelerates a velocity of the vehicle based on the detected distance to maintain a safe distance from the preceding vehicle.

Recently, an SCC system cooperating with a navigation system has been developed. The SCC system receives velocity limit information from the navigation system and controls an acceleration and a deceleration of a vehicle velocity, based on the received velocity limit information.

Another SCC system cooperating with the navigation system receives road state information from the navigation system, checks a state of a road, on which a vehicle is driving, based on the received road state information, and controls a deceleration or an acceleration of a vehicle velocity, based on the checked road state. That is, the other SCC system cooperating with the navigation system determines whether the road has an uphill portion, a downhill portion, and/or a velocity bump, based on the received road state information and controls a deceleration or an acceleration of the vehicle velocity, based on a result of the determination.

However, the above-described systems of the related art are additional technologies that are applied to a cruise control system, which allows a vehicle to mainly drive at a normal velocity, or applied to only a specific environment such as a velocity limit section, but cannot contribute to enhance the normal performance of an SCC system that maintains a distance from a preceding vehicle and controls a vehicle velocity. That is, it is difficult for the related art SCC technologies, cooperating with a navigation system, to enhance the normal performance of an SCC system that recognizes a preceding vehicle with radar to choose a target vehicle and follows the chosen target vehicle.

Therefore, it is required to develop an SCC system for enhancing the intrinsic performance of the SCC system that maintains a distance from a preceding vehicle and controls a vehicle velocity by using navigation information received from a navigation system, in addition to providing an addition function by using the navigation information received from the navigation system.

### SUMMARY

Accordingly, the present invention provides an SCC system and a control method thereof, which enhance the intrinsic performance of the SCC system by using navigation information received from a navigation system.

In one general aspect, a smart cruise control (SCC) system, which controls acceleration or deceleration of a driver's vehicle to maintain a safe distance from preceding vehicles, includes: a control unit configured to determine a road environment, in which the driver's vehicle is driving, based on road information supplied from a navigation, choose a target vehicle from among the preceding vehicles by using a parameter which is adaptively set depending on the determined road environment, and calculate a target acceleration of the driver's vehicle, based on the chosen target vehicle; and a braking unit configured to control acceleration or deceleration of the driver's vehicle, based on the target acceleration.

In another general aspect, a control method of a smart cruise control (SCC) system, which controls acceleration or deceleration of a driver's vehicle to maintain a safe distance from preceding vehicles, includes: determining a road environment in which the driver's vehicle is driving, based on road information supplied from a navigation; adaptively applying a parameter associated with a choice of a target vehicle depending on the road environment to choose a target vehicle; calculating a target acceleration of the driver's vehicle, based on the chosen target vehicle; and controlling acceleration or deceleration of the driver's vehicle, based on the target acceleration.

Other features and aspects will be apparent from the following detailed description, the drawings, and the claims.

### BRIEF DESCRIPTION OF THE DRAWINGS

FIG. 1 is a block diagram a whole configuration of an SCC system according to an embodiment of the present invention.

FIG. 2 is a block diagram illustrating a configuration of a control unit illustrated in FIG. 1.

FIGS. 3A and 3B are diagrams illustrating a forward-looking distance and path widths which are parameters associated with a choice of a target vehicle, according to an embodiment of the present invention.

FIG. 4 is a diagram for describing tuning of the parameter illustrated in FIG. 3A.

FIG. 5 is a diagram for describing tuning of the parameter illustrated in FIG. 3B.

FIGS. 6A, 6B and 7 are diagrams for describing tuning of a threshold time value which is a parameter associated with a choice of a target vehicle, according to an embodiment of the present invention.

FIGS. 8A and 8B are a flowchart illustrating a control method of the SCC system illustrated in FIG. 1.

### DETAILED DESCRIPTION OF EMBODIMENTS

A general SCC system may collect object recognition information and vehicle driving information from a sensor including a radar sensor installed in a vehicle to choose a target vehicle, and may control acceleration or deceleration of a vehicle, based on the chosen target vehicle. In this case, in the general SCC system, a parameter associated with a choice of a target vehicle is not used to choose the target vehicle in consideration of a road environment such as a highway, general road, or the like.

In a downtown congestion section, there are many cases where a driver's vehicle is close to a preceding vehicle which is driving on a lane next to a driving lane of the driver's vehicle, and a peripheral vehicle cuts in front of the driver's vehicle. For this reason, for safety, an SCC system should quickly recognize, as a target vehicle, a preceding vehicle which suddenly cuts in a driver's vehicle.

However, the SCC system which is set to quickly recognize a preceding vehicle as a target vehicle may choose a preceding vehicle as a target vehicle despite that a distance between a driver's vehicle and the preceding vehicle is sufficient in a highway environment, and may perform unnecessary braking.

Therefore, the present invention may determine a road environment in which a driver's vehicle is driving, and may adaptively set a parameter, used to choose a target vehicle, depending on the determined road environment.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

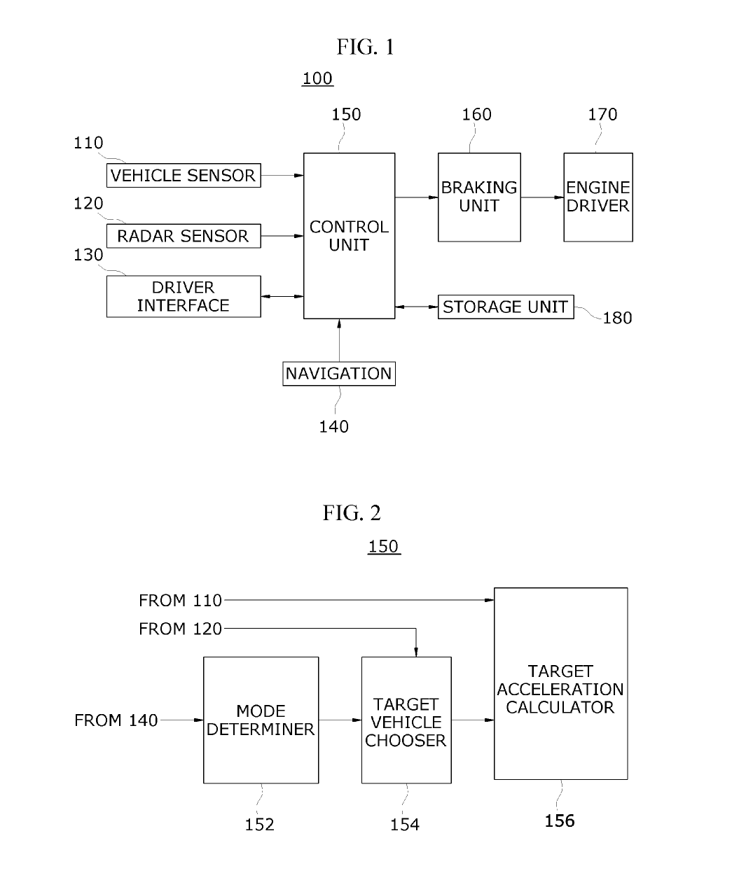

FIG. 1 is a block diagram a whole configuration of an SCC system 100 according to an embodiment of the present invention.

Referring to FIG. 1, the SCC system 100 according to an embodiment of the present invention may determine a normal driving control mode and a high velocity driving control mode depending on a road environment in which a driver's vehicle is currently driving, and may perform SCC suitable for the determined control mode.

To this end, the SCC system 100 according to an embodiment of the present invention may include a vehicle sensor 110, a radar sensor 120, a driver interface 130, a navigation 140, a control unit 150, a braking unit 160, an engine driver 170, and a storage unit 180.

The vehicle sensor 110 may include a steering angle sensor that senses a steering angle of a driver's vehicle, a yaw rate sensor that senses a rotation angular velocity of the driver's vehicle, and a vehicle velocity sensor that senses a velocity of the driver's vehicle. A steering angle sensed by the steering angle sensor, a rotation angular velocity sensed by the yaw rate sensor, and a vehicle velocity sensed by the vehicle velocity sensor may be supplied to the control unit 150 as driving information of the driver's vehicle.

The radar sensor 120 may sense a relative velocity of and a relative distance from a preceding vehicle by using radar and may supply a result of the sensing to the control unit 150 as vehicle recognition information for recognizing the preceding vehicle.

The driver interface 130 may be an element that interfaces the driver with the control unit 150. The driver interface 130 may supply user input information to the control unit 150. Here, the user input information may include a start command and an end command of SCC and a setting command for cooperating with the navigation 140.

The navigation 140 may receive a global positioning system (GPS) signal from a GPS satellite, extract navigation information from the received GPS signal, and supply the extracted navigation information to the control unit 150. The navigation information may include road information, indicating whether a road on which the driver's vehicle is driving is a highway or a general road, and current position information of the driver's vehicle.

The control unit 150 may collect driver's vehicle driving information from the vehicle sensor 110, vehicle recognition information from the radar sensor 120, and road information from the navigation 140, tune a parameter associated with a choice of a target vehicle by using the collected information, and choose the target vehicle, based on the tuned parameter. Also, the control unit 150 may calculate a target acceleration, based on the chosen target vehicle.

The braking unit 160 may transfer a required engine torque, calculated based on the target acceleration, to the engine driver 170.

The engine driver 170 may drive an engine of the driver's vehicle according to the required engine torque to control acceleration or deceleration of the driver's vehicle.

The storage unit 180 may store a parameter, which is initially set (defaulted) for choosing a target vehicle, and a parameter to which the initially set parameter is tuned by the control unit 150. The storage unit 180 may include, for example, a nonvolatile memory device such as a read only memory (ROM), a random access memory (RAM), a programmable ROM (PROM), an erasable programmable ROM (EPROM), or the like, and/or may include a storage medium such as a hard disk, an optical disk, or the like.

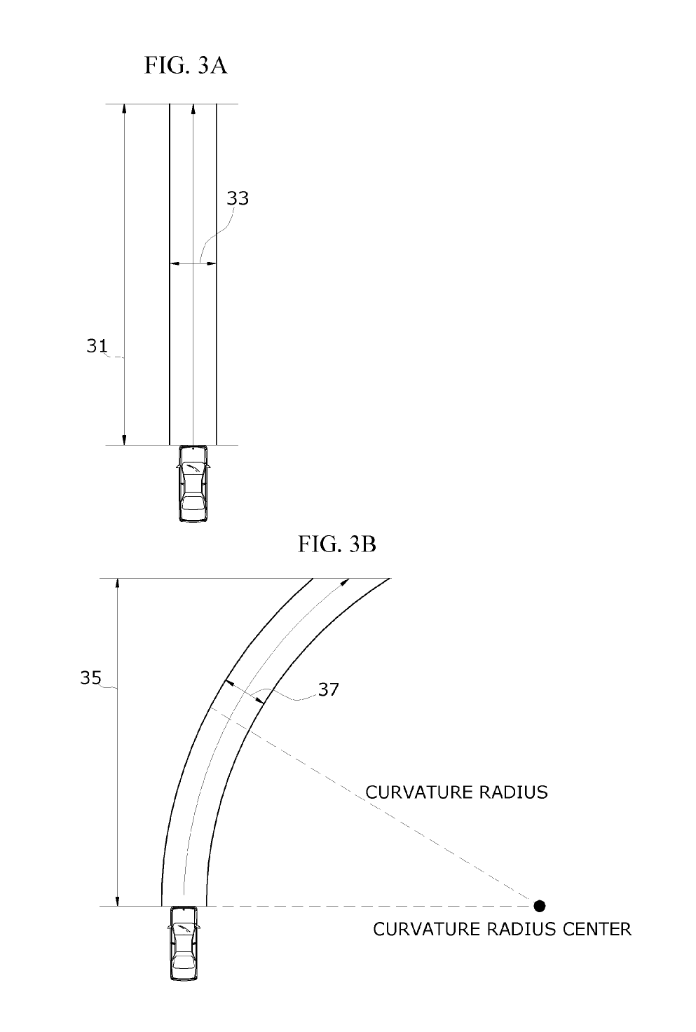

FIG. 2 is a block diagram illustrating a configuration of the control unit 150 illustrated in FIG. 1.

Referring to FIG. 2, the control unit 150 may include a mode determiner 152, a target vehicle chooser 154, and a target acceleration calculator 155.

The mode determiner 152 may determine a road environment in which the driver's vehicle is currently driving, and may determine a normal driving control mode (or a first control mode) and a high velocity driving control mode (or a second control mode) depending on the determined road environment.

In detail, the mode determiner 152 may be supplied with road information, shown in the following Table 1, from the navigation 140 and may determine whether a road environment in which the driver's vehicle is driving is a highway or a general road, based on the supplied road information.

When the road environment in which the driver's vehicle is driving is the general road, the mode determiner 152 may determine a control mode of the SCC system as the normal driving control mode (or the first control mode). When the road environment in which the driver's vehicle is driving is the highway, the mode determiner 152 may determine the control mode of the SCC system as the high velocity driving control mode (or the second control mode).

TABLE 1

| | | | Bit | Init | Error |
|---|---|---|---|---|---|
| Signal Label | Signal designation | Bit add. | ind. | value | ident |
| Message | | Identifier. 0533H | | | |
| CurRoad_Class | Class of Current Road | 52 | 4 | 0H | FH |
| | 0x0: Default | | | | |
| | 0x1: Highway | | | | |
| | 0x2: City Highway | | | | |
| | 0x3: National Road | | | | |
| | 0x4: National Locality | | | | |
| | road | | | | |
| | 0x5: Locality Road | | | | |
| | 0x6: General Road | | | | |
| | 0x7: Narrow Road | | | | |
| | 0x8: Ferry | | | | |
| | 0x9~0xE: Reserved | | | | |
| | 0x0: Invalid | | | | |

According to Table 1, the mode determiner 152 may check a road environment field “CurRoad_Class” of road information supplied from the navigation 40, and when an indicator “0x1” indicating a highway is recorded in the road environment field, the mode determiner 152 may determine, as a highway, a road environment in which the driver's vehicle is driving. When another indicator other than the indicator “0x1” is recorded in the road environment field “CurRoad_Class”, the mode determiner 152 may determine, as a general road, the road environment in which the driver's vehicle is driving.

The target vehicle chooser 154 may tune a parameter associated with a choice of a target vehicle according to a control mode (or a road environment) determined by the mode determiner 152 and may choose a target vehicle from among preceding vehicles by using the tuned parameter.

The parameter may include a first parameter and a second parameter. The target vehicle chooser 154 may choose the target vehicle by using the first parameter in the normal driving control mode (or the first control mode), and in the high velocity driving control mode (or the second control mode), the target vehicle chooser 154 may choose the target vehicle by using the second parameter.

The parameter may be a choice criterion of a target vehicle from among preceding vehicles. When desiring to choose a target vehicle according to a low choice criterion, the first parameter may be used, and when desiring to choose a target vehicle according to a relatively high choice criterion, the second parameter may be used.

That is, the target vehicle chooser 154 may choose the target vehicle according to a low choice criterion on a general road. Also, the target vehicle chooser 154 may choose the target vehicle according to a high choice criterion on a highway.

The parameter associated with the choice criterion may be defined as a value which defines a region of interest (ROI) (or a driving path) of the driver's vehicle. In this case, an operation of increasing or lowering the choice criterion of the target vehicle may be achieved by tuning a size of the ROI.

A parameter associated with the ROI may include, for example, a forward-looking distance and a driving path width (hereinafter referred to as a path width) corresponding to the forward-looking distance.

In addition, the parameter may further include a threshold time value. The threshold time value may be defined as a reference value compared with a time value where a target vehicle stays in the ROI.

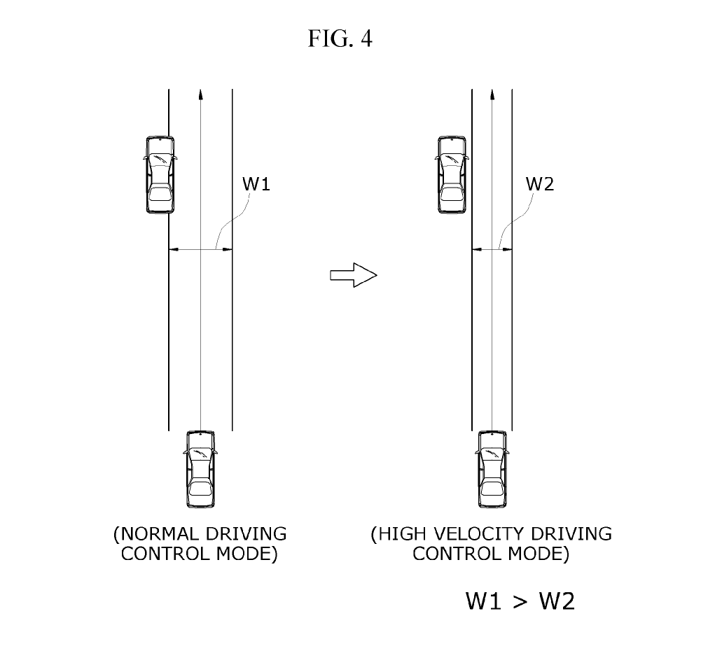

Parameters and an operation of tuning the parameters according to a road environment will be described in detail with reference to FIGS. 3 to 7.

The target acceleration calculator 156 may calculate a target acceleration by using information (hereinafter referred to as target vehicle information) of a target vehicle chosen by the target vehicle chooser 154, driver's vehicle driving information supplied from the vehicle sensor 110, and a distance information between the driver's vehicle and the target vehicle supplied from the radar sensor 120.

The calculated target acceleration may include a first target acceleration and a second target acceleration. Here, the first target acceleration may be calculated based on driver's vehicle driving information such as distance information between the driver's vehicle and a target vehicle which is chosen based on the tuned parameter, a velocity of the driver's vehicle, a steering angle of the driver's vehicle, a rotation angular velocity of the driver's vehicle, and/or the like. Also, the second target acceleration may be calculated based on driver's vehicle driving information such as distance information between the driver's vehicle and a target vehicle which is chosen based on the defaulted parameter, the velocity of the driver's vehicle, the steering angle of the driver's vehicle, the rotation angular velocity of the driver's vehicle, and/or the like.

The first target velocity and the second target velocity may be supplied from the braking unit 160, and the braking unit 160 may calculate a first required engine torque corresponding to the first target acceleration or a second required engine torque corresponding to the second target acceleration and may supply the calculated first required engine torque or second required engine torque to the engine driver 170.

The engine driver 170 may control acceleration or deceleration of an engine, based on the first required engine torque or the second required engine torque.

Hereinafter, a parameter tuned by the target vehicle chooser 156 will be described in detail with reference to FIGS. 3 to 7.

Forward-Looking Distance and Path Width

In FIGS. 3A and 3B, a forward-looking distance 31 and a path width 33 are illustrated as parameters for choosing a target vehicle.

FIG. 3A illustrates the forward-looking distance 31 and the rectilinear path width 33 on a rectilinear road, and FIG. 3B illustrates a forward-looking distance 35 and a rectilinear path width 37 on a curve road. The forward-looking distance 35 on the curve road may be calculated based on a curvature radius which is extracted based on steering angle information and a rotation angular velocity.

The target vehicle chooser 154 may determine whether a preceding vehicle exists in the forward-looking distances and the path widths 33 and 35 illustrated in FIGS. 3A and 3B, and when it is determined that the preceding vehicle exists, the target vehicle chooser 154 may choose the preceding vehicle as a target vehicle.

The target vehicle chooser 154 tuning a parameter depending on a road environment denotes tuning of the forward-looking distances and the path widths 33 and 35 illustrated in FIGS. 3A and 3B.

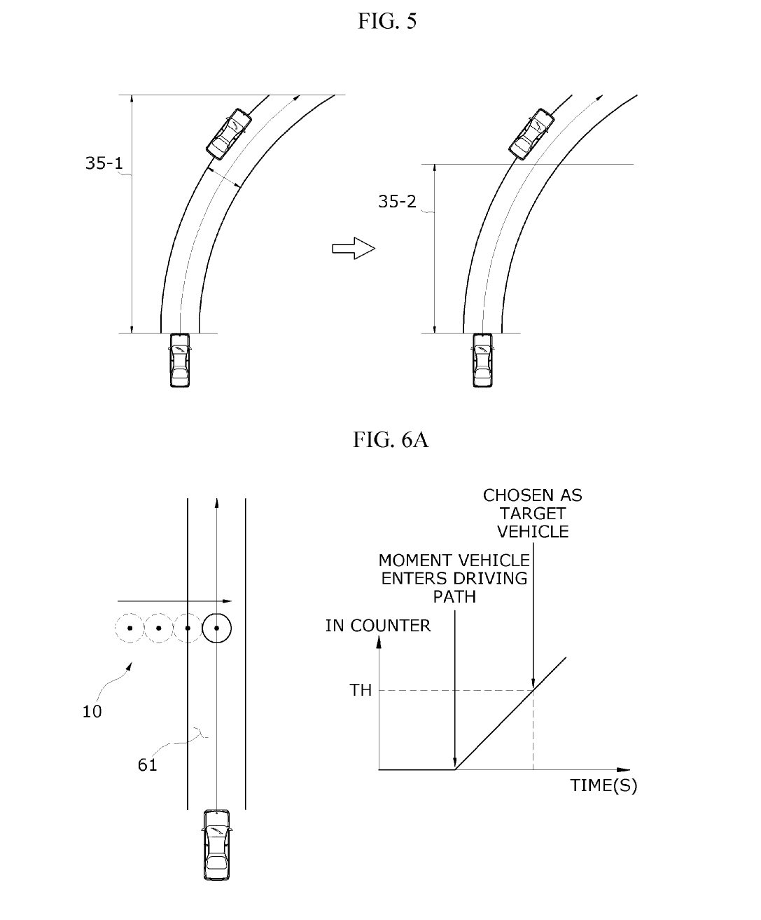

For example, when the driver's vehicle drives on a rectilinear road in a highway environment, as illustrated in FIG. 4, the target vehicle chooser 154 may tune a path width to a path width W2 narrower than a previously set path width W1 in the normal driving control mode and may choose, as a target vehicle, a preceding vehicle that enters into the path width W2 obtained through the tuning.

As described above, in the high velocity driving control mode, a choice criterion of a target vehicle may be lowered by tuning a path width to a narrower path width to intentionally delay a time when the target vehicle is chosen.

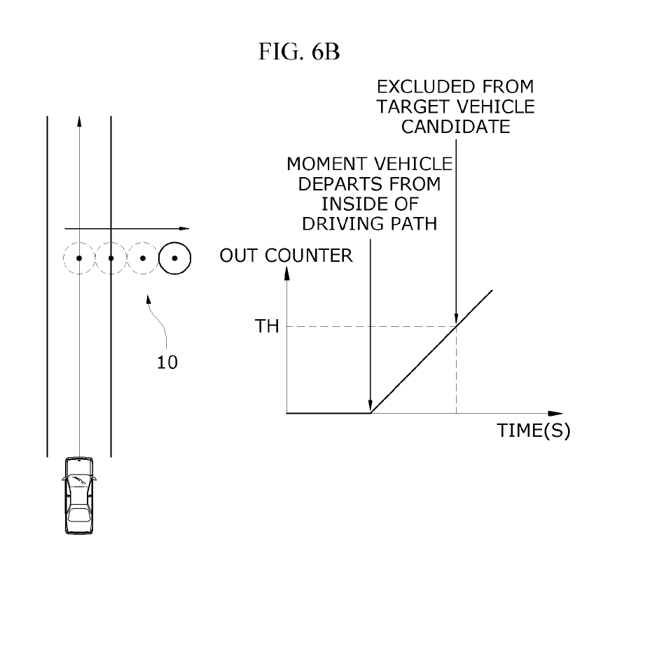

Moreover, when the driver's vehicle drives on a curve road in the highway environment, as illustrated in FIG. 5, the target vehicle chooser 154 may tune a forward-looking distance to a forward-looking distance 35-2 shorter than an initially set forward-looking distance 35-1 in the normal driving control mode, thereby reducing a probability that a preceding vehicle at a long distance is unnecessarily sensed as a target vehicle.

Threshold Time Value

As described above, a threshold time value which is another parameter used to choose a target vehicle may be a threshold time value compared with a time value where a preceding vehicle stays in a driving path which is defined by a forward-looking distance and a path width.

A timing when a preceding vehicle is chosen as a target vehicle may be controlled by tuning a driving time threshold value, thereby reducing a probability that a preceding vehicle is unnecessarily chosen as a target vehicle.

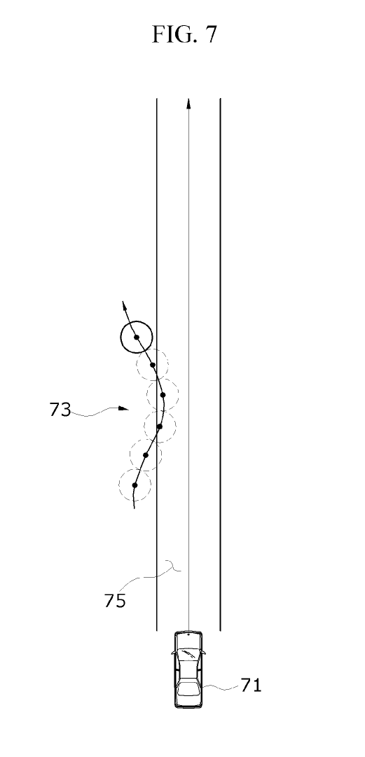

For example, as illustrated in FIG. 6A, a preceding vehicle 10 may enter into a driving path 61 defined by a forward-looking distance and a path width, and then, a time for which the preceding vehicle 10 stays in the driving path 61 may be counted. When the counted time reaches a first threshold time value TH1, the preceding vehicle 10 may be chosen as a target vehicle.

On the other hand, as illustrated in FIG. 6B, a time may be counted from a time when the preceding vehicle 10 departs from the driving path 61, and when the counted time reaches a second threshold time value TH2, the preceding vehicle 10 may be excluded from the target vehicle.

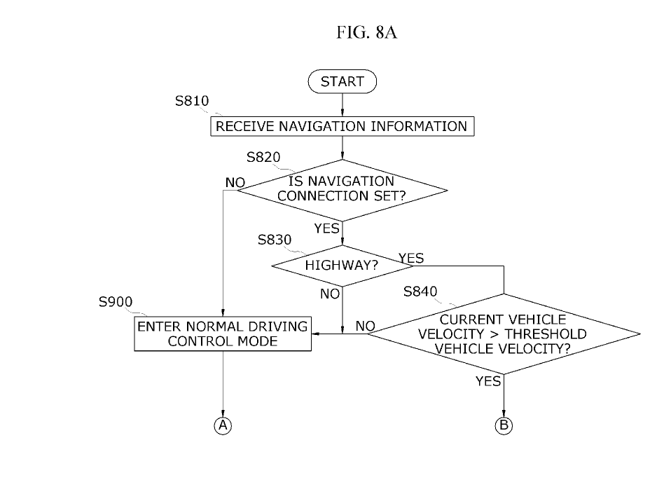

A situation, where a driver finds a preceding vehicle quickly moving across the front of the driver's vehicle while the driver's vehicle is driving on a highway, may be not recognized as a dangerous situation, or as illustrated in FIG. 7, a situation where a preceding vehicle 73 stays in a driving path 75 of a driver's vehicle 71 for only a short time and then returns to a driving path of the preceding vehicle 73 may not be recognized as the dangerous situation.

As described above, if a preceding vehicle which quickly moves across the front of a driver's vehicle or a preceding vehicle which stays in a driving path of a driver's vehicle for a short time and then quickly returns to a driving path of the preceding vehicle is chosen as a target vehicle and thus acceleration or deceleration of a vehicle is automatically controlled, acceleration or deceleration of a vehicle is automatically controlled despite a situation undesired by a driver.

A traffic situation on a general road is relatively further congested than a traffic situation on a highway, and thus, when a preceding vehicle enters a driving path of a driver's vehicle on a general road, the preceding vehicle may be quickly chosen as a target vehicle. Accordingly, the target vehicle chooser 154 may maintain an initially set threshold time value as-is or may tune a threshold time value to a time value which is less than the initially set threshold time value.

On the other hand, when a preceding vehicle enters a driving path of a driver's vehicle on a highway, a time when the preceding vehicle is chosen as a target vehicle may be delayed. Accordingly, the target vehicle chooser 154 may tune the threshold time value to a time value which is greater than the initially set threshold time value.

Since the threshold time value has been tuned to a high value, a preceding vehicle which departs from a driving path of a driver's vehicle for a short time and then returns to the driving path of the driver's vehicle may be maintained as a target vehicle.

As described above, since a threshold time value compared with a driving time (a time when a preceding vehicle stays in a driving path of a driver's vehicle) of the preceding vehicle which drives in the driving path of the driver's vehicle is adaptively tuned depending on a road environment, the SCC system 100 according to an embodiment of the present invention efficiently controls acceleration or deceleration of a vehicle depending on a road environment.

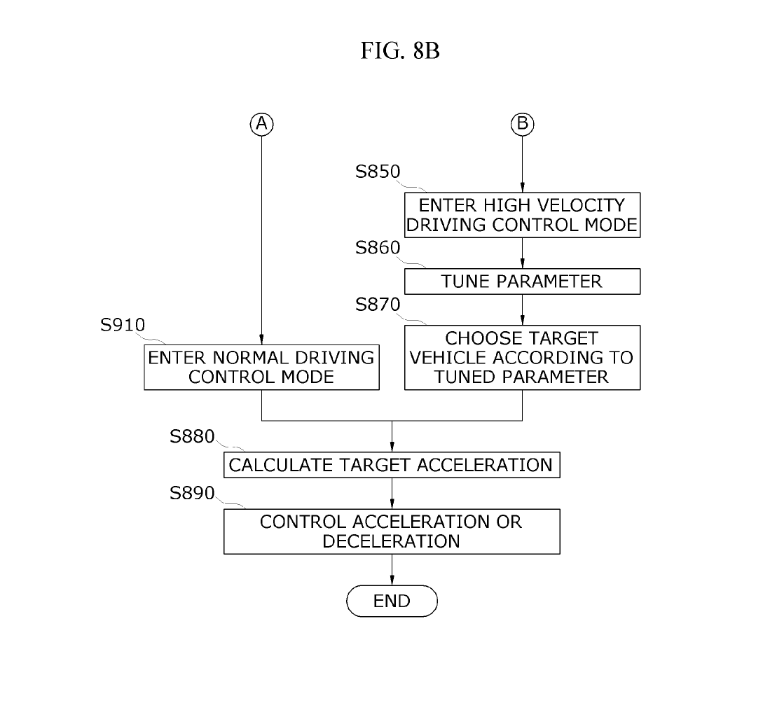

FIGS. 8A and 8B are a flowchart illustrating a control method of the SCC system 100 illustrated in FIG. 1. To help understand description, FIG. 1 will be referred to along with FIGS. 8A and 8B.

Referring to FIG. 8A, in step S810, the control unit 150 may receive navigation information from the navigation 140.

Subsequently, in step S820, the control unit 150 may determine whether to set a connection between the navigation 140 and the SCC system installed in a vehicle, based on a driver input received through the driver interface 130.

In detail, when the control unit 150 receives, through the driver interface 130, an off command for breaking a connection between the SCC system and the navigation 140, the control unit 150 may enter the normal driving control mode in step S900.

On the other hand, when the control unit 150 receives, through the driver interface 130, an on command for establishing a connection between the SCC system and the navigation 140, by using navigation information supplied from the navigation 140, the control unit 150 may determine whether a driver's vehicle is driving on a highway in step S830.

When it is determined that a current driving road of the driver's vehicle is the highway, the control unit 150 may compare a current velocity of the driver's vehicle with a threshold vehicle velocity in step 840. Here, the threshold vehicle velocity may be a statistic value for distinguishing an average vehicle velocity on a highway from an average vehicle velocity on a general road.

When a driver's vehicle drives at a velocity lower than the threshold vehicle velocity, the driver's vehicle may be recognized as driving on a general road, and a target vehicle may be chosen based on a parameter which is set in the normal driving control mode. Therefore, a risk of a vehicle accident is reduced.

On the other hand, a high velocity driving situation occurs on a general road, but since there is a high possibility that an unexpected situation occurs due to a traffic signal and/or a complicated road environment, if a driving road environment of a driver's vehicle is not a highway environment, the driver's vehicle may fundamentally operate in the normal driving control mode in other environments.

Referring to FIG. 8B, When a current velocity of the driver's vehicle is higher than the threshold vehicle velocity, the control unit 150 may operate in the high velocity driving control mode in step S850.

Subsequently, in the high velocity driving control mode, the control unit 150 may tune a parameter associated with a choice of a target vehicle to lower a choice criterion of the target vehicle in step S860. Here, the choice criterion of the target vehicle may be expressed as a sensing probability of the target vehicle.

Subsequently, the control unit 150 may choose the target vehicle according to the tuned parameter in step S870, and may calculate a target vehicle velocity of the driver's vehicle, based on the chosen target vehicle in step S880.

Subsequently, the control unit 150 may control acceleration or deceleration of the driver's vehicle, based on the calculated target acceleration.

The control unit 150 which operates in the normal driving control mode through step S900 may choose a target vehicle according to an initially set parameter, for increasing a choice criterion of a target vehicle which is sensed in a driving path of the driver's vehicle in step 910, and may sequentially perform steps S880 and S890 of controlling a target acceleration and acceleration or deceleration of the driver's vehicle, based on the chosen target vehicle.

As described above, the present chooses a target vehicle by using a parameter adaptive to a road environment, based on road information supplied from a navigation, and thus, a parameter design is not limited in terms of a developer.

Moreover, according to the embodiments of the present invention, the SCC system may determine a road environment by using navigation information and may adaptively apply parameters associated with a choice of a target vehicle for preceding vehicle follower control depending on the road environment, thereby performing smart cruise control optimized for the road environment. Accordingly, the performance of the SCC system is improved, and customers' satisfaction for the SCC system increases.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A smart cruise control (SCC) system, which controls acceleration or deceleration of a driver's vehicle to maintain a safe distance from preceding vehicles, comprising:
a control unit configured to determine a road environment, in which the driver's vehicle is driving, based on road information supplied from a navigation, choose a target vehicle from among the preceding vehicles by using a parameter which is adaptively set depending on the determined road environment, and calculate a target acceleration of the driver's vehicle, based on the chosen target vehicle; and
a braking unit configured to control acceleration or deceleration of the driver's vehicle, based on the target acceleration.

2. The SCC system of claim 1, wherein the control unit determines whether the road environment in which the driver's vehicle is driving is a general road or a highway, based on the road information supplied from the navigation.

3. The SCC system of claim 1, wherein
when the road environment in which the driver's vehicle is driving is a general road, the control unit calculates the target acceleration by using a first parameter which is obtained by lowering a choice criterion of a target vehicle, and
when the road environment in which the driver's vehicle is driving is the highway, the control unit calculates the target acceleration by using a second parameter which is obtained by tuning the first parameter to increase the choice criterion of the target vehicle.

4. The SCC system of claim 1, wherein the control unit comprises:
a mode determiner configured to determine whether the road environment in which the driver's vehicle is driving is a general road or a highway, based on the road information supplied from the navigation, wherein when the road environment in which the driver's vehicle is driving is the general road, the mode determiner determines a first control mode, and when the road environment in which the driver's vehicle is driving is the highway, the mode determiner determines a second control mode;
a target vehicle chooser configured to choose a target vehicle from among the preceding vehicles in the first control mode, based on a parameter associated with a choice of the target vehicle, tune the parameter in the second control mode, and choose the target vehicle, based on the tuned parameter; and
a target acceleration calculator configured to calculate a first target acceleration with respect to the chosen target vehicle, based on the parameter, and calculate a second target acceleration with respect to the chosen target vehicle, based on the tuned parameter.

5. The SCC system of claim 4, wherein the parameter comprises at least one of a forward-looking distance of the driver's vehicle, a path width corresponding to the forward-looking distance, and a threshold time value compared with a time value in which a target vehicle stays in a region of interest (ROI) of the driver's vehicle.

6. The SCC system of claim 5, wherein
the forward-looking distance comprises a first forward-looking distance and a second forward-looking distance shorter than the first forward-looking distance, and
the target vehicle chooser chooses the target vehicle by using the first forward-looking distance in the first control mode, and in the second control mode, the target vehicle chooser chooses the target vehicle by using the second forward-looking distance.

7. The SCC system of claim 5, wherein
the path width comprises a first path width and a second path width narrower than the first path width, and
the target vehicle chooser chooses the target vehicle by using the first path width in the first control mode, and in the second control mode, the target vehicle chooser chooses the target vehicle by using the second path width.

8. The SCC system of claim 5, wherein
the threshold time value comprises a first threshold time value and a second threshold time value greater than the first threshold time value, and
the target vehicle chooser chooses the target vehicle by using the first threshold time value in the first control mode, and in the second control mode, the target vehicle chooser chooses the target vehicle by using the second threshold time value.

9. A control method of a smart cruise control (SCC) system which controls acceleration or deceleration of a driver's vehicle to maintain a safe distance from preceding vehicles, the control method comprising:
determining a road environment in which the driver's vehicle is driving, based on road information supplied from a navigation;
adaptively applying a parameter associated with a choice of a target vehicle depending on the road environment to choose a target vehicle;
calculating a target acceleration of the driver's vehicle, based on the chosen target vehicle; and
controlling acceleration or deceleration of the driver's vehicle, based on the target acceleration.

10. The control method of claim 9, wherein the determining of the road environment comprises determining whether the road environment is a general road or a highway, based on the road information.

11. The control method of claim 10, wherein the choosing of the target vehicle comprises:
when the road environment is the general road, choosing the target vehicle from among the preceding vehicles by using a first parameter which is low in choice criterion for choosing the target vehicle; and
when the road environment is the highway, choosing the target vehicle by using a second parameter which is high in choice criterion.

12. The control method of claim 10, wherein
the parameter comprises a first forward-looking distance of the driver's vehicle and a second forward-looking distance shorter than the first forward-looking distance, and
the choosing of the target vehicle comprises:
when the road environment is the general road, choosing the target vehicle by using the first forward-looking distance; and
when the road environment is the highway, choosing the target vehicle by using the second forward-looking distance.

13. The control method of claim 10, wherein
the parameter is a path width corresponding to a forward-looking distance of the driver's vehicle,
the path width comprises a first path width and a second path width narrower than the first path width, and
the choosing of the target vehicle comprises:
when the road environment is the general road, choosing the target vehicle by using the first path width; and
when the road environment is the highway, choosing the target vehicle by using the second path width.

14. The control method of claim 10, wherein
the parameter is a threshold time value compared with a time value in which the target vehicle stays in a region of interest (ROI) of the driver's vehicle,
the threshold time value comprises a first threshold time value and a second threshold time value greater than the first threshold time value, and
the choosing of the target vehicle comprises:
when the road environment is the general road, choosing the target vehicle by using the first threshold time value; and
when the road environment is the highway, choosing the target vehicle by using the second threshold time value.
